(19) United States
(12) Patent Application Publication
(10) Pub. No.: US 2024/0412044 A1
(43) Pub. Date: Dec. 12, 2024

(54) MACHINE LEARNING FOR AUTOMATIC CASING ANOMALY CLASSIFICATION FROM ELECTROMAGNETIC DATA

(71) Applicant: Saudi Arabian Oil Company, Dhahran (SA)

(72) Inventors: Yahia Ahmed Eltaher, Dhahran (SA); Chicheng Xu, Houston, TX (US); Lei Fu, Houston, TX (US)

(21) Appl. No.: 18/330,507

(22) Filed: Jun. 7, 2023

(51) Int. Cl. G06N 3/0464; G06N 3/08

(52) U.S. Cl. CPC G06N 3/0464; G06N 3/08

(57) ABSTRACT

Implementations provide a computer-implemented method that includes: accessing a first database holding results of interpreting casing integrity, wherein each result provides a first or a second label for a detected anomaly at a depth location of an inspection log that records electromagnetic (EM) survey data of an underground metal casing; accessing a second database holding inspection logs, each recording EM survey data of a corresponding underground metal casing; training a deep learning model configured to classify an input inspection log into the first or the second label; applying the deep learning model to one or more unclassified inspection logs of the second database, wherein the one or more unclassified inspection logs of the second database comprising anomalies; and subsequently classifying the one or more unclassified inspection logs of the second database into either the first label or the second label.

### TECHNICAL FIELD

This disclosure generally relates to monitoring well integrity in the gas and oil exploration industry.

### BACKGROUND

Well integrity is subject to constant monitoring during the life span of a well and as part of field management, especially for mature oil and gas fields. One of the most prominent means of well casing integrity evaluation is electromagnetic (EM) logging. An EM logging tool can leverage multiple operating principles to detect changes in casing pipe thickness. The detected change can be translated into a metal loss percentage using signal processing techniques after raw data has been captured. As to the raw data, it may undergo multiple steps (e.g., filtering, editing, normalization) before data interpretation can be performed.

### SUMMARY

In one aspect, some implementations provide a computer-implemented method that includes: accessing a first database holding results of interpreting casing integrity, wherein each result provides a label for a detected anomaly at a depth location of an inspection log, wherein the label is one of: a first label of actual metal loss, or a second label of anomaly due to other factors, and wherein the inspection log records electromagnetic (EM) survey data of an underground metal casing that runs a plurality of depth locations; accessing a second database holding inspection logs, wherein each inspection log record EM survey data of a corresponding underground metal casing that runs the plurality of depth locations; based on, at least in part, the results of interpreting casing integrity, training a deep learning model configured to classify an input inspection log comprising an anomaly into the first label or the second label; applying the deep learning model to one or more unclassified inspection logs of the second database, wherein the one or more unclassified inspection logs of the second database comprising anomalies; and subsequently classifying the one or more unclassified inspection logs of the second database into either the first label or the second label.

Implementations may include one or more of the following features.

The computer-implemented method may further include: analyzing the one or more unclassified inspection logs of the second database such that the anomalies in the one or more unclassified inspection logs are detected. Each result from the first database may be generated based on, at least in part, a determination by one or more human experts when presented with the inspection log along with the anomaly. Each result from the first database may be generated in view of a schematic of the underground metal casing at the plurality of depth locations. The schematic of the underground metal casing may reveal at least one of: an eccentric casing pipe configuration, a decentered casing pipe configuration, and a casing pipe size transition. The EM survey data may include an EM spectrum map corresponding to recorded EM decay curves from each transmitter-receiver combination on an EM logging tool lowered into the underground metal casing. The first label may be characterized by a trapezoid pattern in the EM spectrum map at a depth location corresponding to the detected anomaly. The deep learning model may include a U-Net classifier. The U-Net classifier may include: a first stage configured to perform a pixel-level classification and classify each pixel or each patch of pixels into either the first label or the second label, and a second stage of using morphological patterns to discriminate detected anomalies according to a respective pattern of each detected anomaly. The deep learning model may include a patch-based image classifier configured to operate on patches of pixels, wherein the patch-based image classifier incorporates a convolutional neural network (CNN) classifier, and wherein the CNN classifier comprises: classifying, as a classified label, patches of each inspection image into one of the first label or the second label; assigning the classified label to a center pixel of the patch; and averaging over adjacent patches.

In another aspect. implementations provide a computer system including one or more computer processors configured to perform operations of: accessing a first database holding results of interpreting casing integrity, wherein each result provides a label for a detected anomaly at a depth location of an inspection log, wherein the label is one of: a first label of actual metal loss, or a second label of anomaly due to other factors, and wherein the inspection log records electromagnetic (EM) survey data of an underground metal casing that runs a plurality of depth locations; accessing a second database holding inspection logs, wherein each inspection log record EM survey data of a corresponding underground metal casing that runs the plurality of depth locations; based on, at least in part, the results of interpreting casing integrity, training a deep learning model configured to classify an input inspection log comprising an anomaly into the first label or the second label; applying the deep learning model to one or more unclassified inspection logs of the second database, wherein the one or more unclassified inspection logs of the second database comprising anomalies; and subsequently classifying the one or more unclassified inspection logs of the second database into either the first label or the second label.

The implementations may include one or more of the following features.

The operations may further include: analyzing the one or more unclassified inspection logs of the second database such that the anomalies in the one or more unclassified inspection logs are detected. Each result from the first database may be generated based on, at least in part, a determination by one or more human experts when presented with the inspection log along with the anomaly. Each result from the first database may be generated in view of a schematic of the underground metal casing at the plurality of depth locations. The schematic of the underground metal casing may reveal at least one of: an eccentric casing pipe configuration, a decentered casing pipe configuration, and a casing pipe size transition. The EM survey data may include an EM spectrum map corresponding to recorded EM decay curves from each transmitter-receiver combination on an EM logging tool lowered into the underground metal casing. The first label may be characterized by a trapezoid pattern in the EM spectrum map at a depth location corresponding to the detected anomaly. The deep learning model may include a U-Net classifier. The U-Net classifier may include: a first stage configured to perform a pixel-level classification and classify each pixel or each patch of pixels into either the first label or the second label, and a second stage of using morphological patterns to discriminate detected anomalies according to a respective pattern of each detected anomaly. The deep learning model may include a patch-based image classifier configured to operate on patches of pixels, wherein the patch-based image classifier incorporates a convolutional neural network (CNN) classifier, and wherein the CNN classifier comprises: classifying, as a classified label, patches of each inspection image into one of the first label or the second label; assigning the classified label to a center pixel of the patch; and averaging over adjacent patches.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The subject matter described in this specification can be implemented to realize one or more of the following advantages. First, various steps of the implementation cannot be performed in the human mind. For example, implementations may access a first database holding voluminous data from field measurements, train a deep learning model based on information from the first database, and apply the deep learning model to unclassified inspection logs from a second database so that the unclassified inspection logs can be classified automatically. Second, the implementations provide a practical application of accurate and automatic classification of inspection logs. In this practical application, a trained deep learning model can be applied to analyze inspection logs so that anomalies in the inspection logs can be accurately and automatically classified into, e.g., an anomaly due to actual metal loss, or an anomaly due to other factors. The capability of automatic differentiation using a training data set adds significantly more to existing technologies.

The details of one or more implementations of the subject matter of this specification are set forth in the description, the claims, and the accompanying drawings. Other features, aspects, and advantages of the subject matter will become apparent from the description. the claims. and the accompanying drawings.

### DESCRIPTION OF DRAWINGS

FIG. 1 illustrates an example of electromagnetic (EM) measurement data for interpretation, according to some implementations of the present disclosure.

FIG. 2 illustrates another example of EM data for interpretation, according to some implementations of the present disclosure.

FIG. 3 illustrates yet another example of EM data for interpretation, according to some implementations of the present disclosure.

FIG. 4 illustrates still another example of EM data for interpretation, according to some implementations of the present disclosure.

FIG. 5 illustrates an example of EM data with a characteristic signature of actual metal loss for interpretation, according to some implementations of the present disclosure.

FIG. 6 illustrates an example of diagram of a machine learning/deep learning framework used, according to some implementations of the present disclosure.

FIG. 7 illustrates an example of work-flow diagram, according to some implementations of the present disclosure.

FIG. 8 is a block diagram illustrating an example of a computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

With the confines of the present disclosure, the terms of “casing pipe,” “casing,” “pipe,” and “tubing” are used interchangeably to refer to a cylindrical metal enclosure used in a downhole of a well. The terms of “machine learning” (ML) and “deep learning” (DL) are used interchangeably to refer to a methodology to train a statistical model based on a training set of input data so that, when the statistical model is applied to new input data, the new input data can be classified according to differentiating features revealed by the statistical model.

The disclosed technology is directed to system and technology to improve the detection of metal loss in casing pipes placed in, e.g., downhole completed well environments. The disclosed technology can apply an ML tool to improve the interpretation of downhole electromagnetic logging data. In particular, the disclosed technology can automatically differentiate features that are attributed to an actual casing pipe metal loss from those attributed to other downhole environmental factors (e.g., change in casing pipe properties or downhole completion effects), where both would induce a similar effect on the electromagnetic raw data used for automated metal loss calculation. By way of background, conventional automated data interpretation techniques would lead to false metal loss calculation because these techniques do not account for such inherited differences. For this reason alone, conventional analysis may leave uncertainty regarding the nature of the measurement result, and is only capable of addressing casing pipe metal loss as an average with a relatively low resolution.

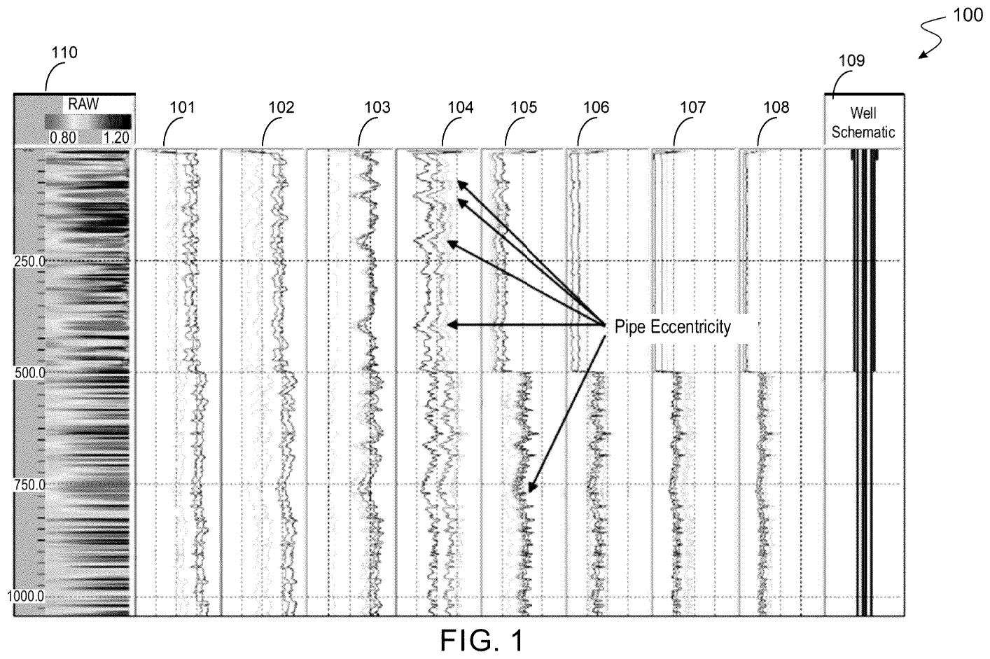

In comparison, the ML techniques used by implementations of the present disclosure can utilize logic that factors in multiple variables, such as a shape of the apparent anomaly, a variation in the feature intensity, and a vertical extent of the length of the feature. Using the ML techniques, implementations of the present disclosure can thus remove the anomaly casing features not related to actual metal loss, and, in doing so, provide a more accurate interpretation of actual metal loss values and optimize well integrity evaluation. Implementations may acquire and analyze electromagnetic data to investigate well integrity issues, for example, with respect to multiple or concentric casing pipes. The unplementations can automatically differentiate anomaly casing features that are not related to actual metal loss from those attributed to changes in casing pipe properties or downhole completion effects. The ML techniques may rely on a large base of training data to build a model, which, when later applied to new measurement data, can identify those anomaly features that correspond to actual metal loss. Details of the implementations are provided below, in association with FIGS. 1-8.

FIG. 1 illustrates an example of electromagnetic (EM) measurement data for interpretation, according to some implementations of the present disclosure.

As illustrated in diagram 100 of FIG. 1, logs 101, 102, 103, 104, 105, 106, 107, and 108, respectively show EM logging data obtained from a total of ninety-three (93) distinct channels as a function of time, displayed in a sequential order, where later channels (sensitive to deeper or bigger casing sizes) are shown on later tracks. Each channel corresponds to a particular arrangement of a transmitter and a receiver placed inside a downhole to investigate well integrity. The transmitter emits EM waves into the downhole while the receiver senses the EM waves and generates a recording. Each channel thus records EM data from a particular transmitter/receiver combination. The recorded EM waveform may generally follow a decaying trend after the emission of the EM waves. The recordings are characteristic of conditions in the downhole at a certain depth (e.g., certain casing pipe size in this case) based upon the proximity of the transmitter/receiver combination, the design of the receivers as sensors, and the loading conditions at the metal casing pipes. For the illustrated channels, recordings from upper (rightward) channels tend to be more sensitive to deeper or bigger casings while recordings from the lower (leftward) channels are more sensitive to casing pipes closer to the tool (e.g., casing pipes with smaller diameter).

Notably, comparing and contrasting log 104 with log 105, the recorded EM data exhibits cyclic changes because of casing pipe eccentricity. This is because an eccentered or decentered casing pipe (e.g., off the vertical axis of the downhole and with a slanted angle with respect to the vertical axis) would be seen to the EM logging tool as less metal, hence would cause a voltage drop. The drop can be interpreted, albeit mistakenly, as an apparent metal loss. As revealed by well schematics 109, diameter change at around depth 500 meter coincides with apparent transitions in EM logs 101 to 108. The appearance is more pronounced for EM logs 105 to 108. Conversely, actual metal loss, according to the position of that part of the casing pipe in the well, can give rise to alterations in recorded waveforms.

Log 110 illustrates the normalized EM spectrum map based on EM measurements using an array of transmitters and receivers. The receivers can record measurements of EM signals (e.g., voltage signals) in response to EM emission on the transmitter. Panel 110 illustrates the waveforms obtained from the entire array in which the vertical axis corresponds to time and the horizontal axis corresponds to each channel of transmitter/receiver combination. The pallet, as converted to a color scale (e.g., a gray scale, as illustrated), is set so that a decrease in voltage is shown in one level of grayness (corresponding to probable metal loss) and an increase in voltage is shown in another, differing level of grayness (corresponding to probable metal gain).

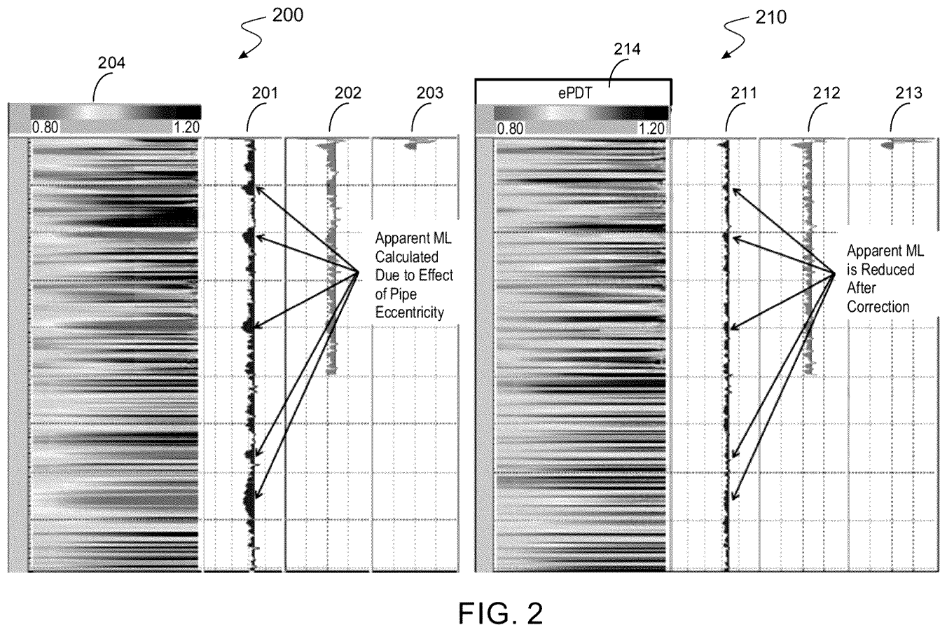

FIG. 2 illustrates another example of EM data for interpretation, according to some implementations of the present disclosure. As illustrated, panel 200 illustrates EM logs 201, 202, and 203, along with EM spectrum map 204. The EM log 201 illustrates apparent metal loss, as detected by simple pattern analysis. As noted above, the false-positive read-out corresponds to the effect of casing pipe eccentricity, which can induce the changes in the EM log that deceptively resemble the appearance of metal loss. Panel 210 illustrates EM logs 211, 212, and 213, along with EM spectrum map 214. By applying corrections to the EM log 211, the apparently metal loss, as detected in EM log 201, has been reduced.

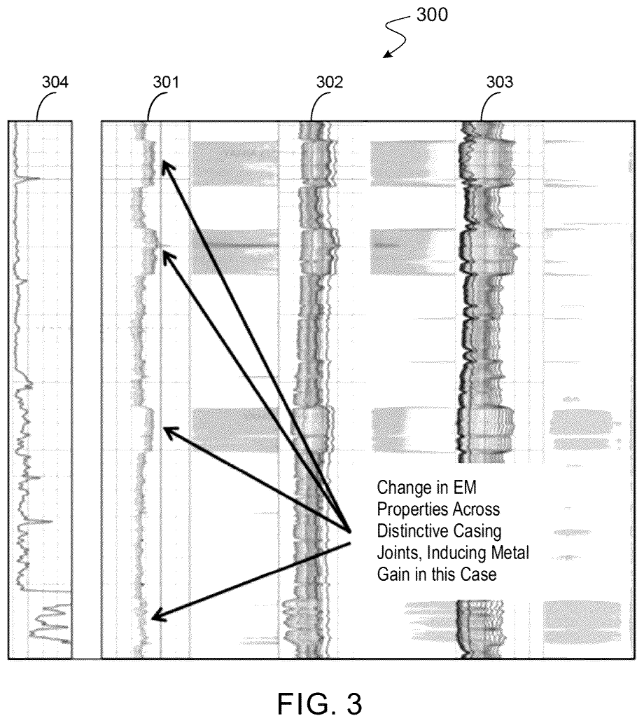

FIG. 3 illustrates yet another example of EM data for interpretation, according to some implementations of the present disclosure. Panel 300 includes EM logs 301, 302, 303, and gamma ray (GR) log 304 (which can detect radioactive isotopes in rocks for lithology analysis). As revealed in EM log 301, changes in EM properties across distinctive casing joints can induce an increase in the voltage signal, and hence the appearance of metal gain in the same casing. The EM properties can include not only casing diameter but also casing pipe weight of several casing joints across the same casing string. These changes caused by inherent property variations in the casing configuration, which can give rise to false-positive readings of metal change.

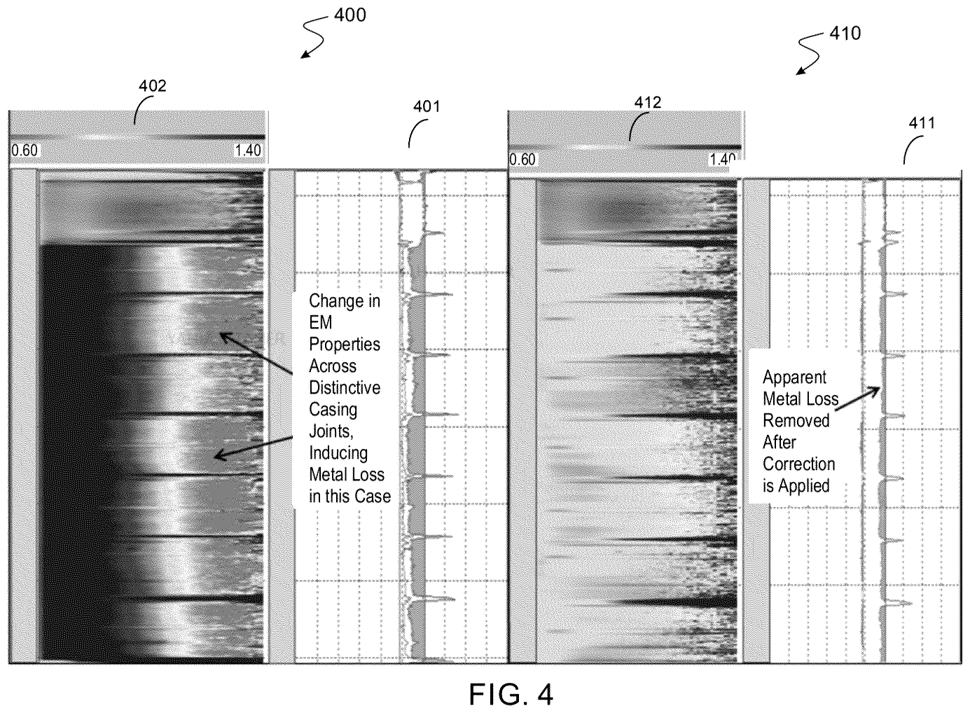

FIG. 4 illustrates still another example of EM data for interpretation, according to some implementations of the present disclosure. Panel 400 illustrates EM log 401 and thickness map 402 (which illustrates the thickness of casing measured around the circumference (horizontal axis) and at various depth (vertical axis). By way of background, the EM spectrum map provides a condensed display of all EM raw data channels, which can indicate metal loss and metal gain. The EM raw data can be processed using models tailored to the specific characteristics of the EM configuration. The thickness map includes the output of the processed raw data. As revealed, the effect of the change in EM properties and/or casing pipe weight of several casing joints across the same casing string can induce a voltage drop measurable in EM log 401, and consequently a corresponding metal loss in appearance, as shown on the calculated thickness map 402. The disruptive joints, as identified in EM log 401 and thickness map 402 can be corrected according to implementations of the present disclosure. EM log 411 and thickness map 412 in panel 410 show results for the same casing after spotting those unique joints and applying the proper corrections in post data processing.

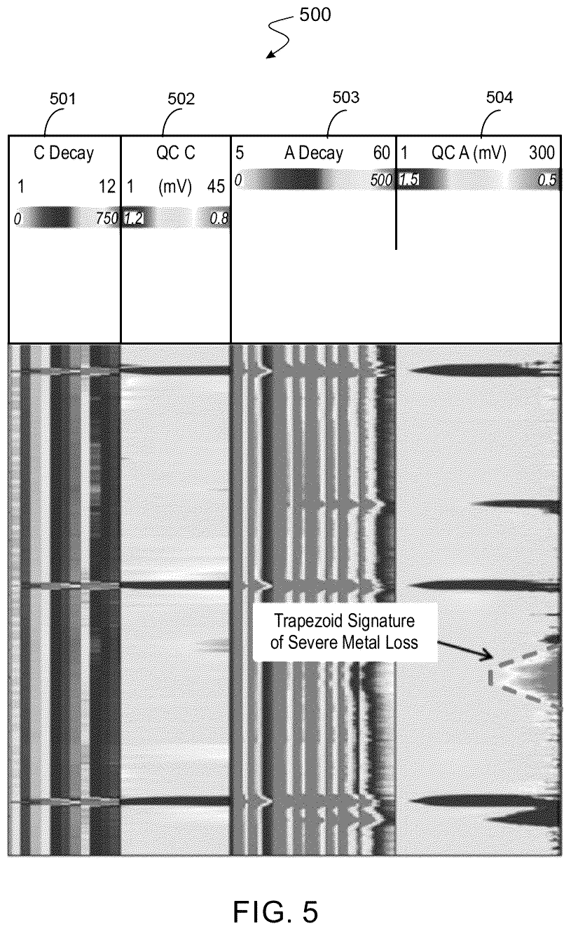

FIG. 5 illustrates an example of EM data with a characteristic signature of actual metal loss for interpretation, according to some implementations of the present disclosure. Panel 500 illustrates an example of a signature of an anomaly that is attributed to actual metal loss across the outer most casing barrier. Metal loss causes a voltage drop on multiple channels as shown on the EM spectrum map 504. As illustrated in FIG. 5, the anomaly takes the shape of a trapezoid with its base being perpendicular to the casing plane, and the tip pointing inward. The extent of the anomaly and effect on log response can be a function of the severity of metal loss and the progression of metal loss among the casing barriers. Panels 501 and 502 provide filter images of the raw EM data decay spectrum for coil configuration C. The filter image in panel 501 is a global image that spans the entire well (or log interval) while the filter image in panel 502 is the median filter image that spans a section of the well to cover a portion of the log interval. Similarly, panels 503 and 504 show respective global and median images for coil configuration A.

Implementations may provide an ML capability of EM data analysis and interpretation. Various factors during EM measurements can affect the detection of anomalies. As demonstrated above, a change in the EM properties of casing joints. when compared to other sections along the same casing string, can induce an apparent gain or loss in metal thickness on the EM spectrum map. Variation in tubing or casing eccentricity, which can be a function of well trajectory, can give rise to changes in EM measurements. For example, lack of proper casing centralization along the vertical direction of a downhole can induce an alternating pattern of apparent gain and loss in metal thickness. Similarly, casing jewelry or completion items on the measurement can induce an apparent metal gain or loss. Examples of casing jewelry or completion items can include R-nipple, FRAC sleeves, float collars, cement valves, packers, pub joints, and seal subs. Additionally, noise (e.g., due to scale depositions on inner surfaces of the casing or metal debris in the wellbore) can also induce an irregular form of metal gain or loss, but may not indicate actual metal loss in the casing pipe.

Some implementations can incorporate a model designed to differentiate features related to actual metal loss, as compared to those attributed to one or more of the reasons mentioned above. The ML/deep learning (DL) model can include several exemplary features to identify true metal loss features. In one example, the ML/DL model can differentiate input patterns by analyzing the shape of the anomaly. By way of illustration. in case of actual metal loss, the feature would mostly take a cone-like shape (or trapezoid shape) that is perpendicular to the vertical plane of the EM spectrum map. The feature of the ML/DL model distinguishes features attributed to EM casing pipe property changes, which can be a homogenous and consistent change across the entire casing joints.

In another example, the ML/DL model can perform differentiation by analyzing the variation in intensity of the feature. As demonstrated in FIGS. 1-5, an anomaly attributed to true metal loss is more likely to exhibit a variable degradation in voltage drop or the magnitude of the signal on the EM spectrum map, among multiple receivers (i.e., entire channel spectrum).

In yet another example, the ML/DL model can pursue differentiation based upon the vertical extent or length of the detected anomaly. As revealed by comparisons in FIGS. 1-5, actual anomalies are unlikely to occur across, for example, an extended length of a joint. In comparison, false-positives caused by transitional changes are likely to be transitory.

Implementations may apply a multiclass segmentation technique based on U-Net, which is a specialized convolutional neural network (CNN), to log images, such as the EM logs and the EM spectrum map. In particular, the multiclass segmentation technique can classify each pixel or pixel patch into one of several integrity states, such as normal, pitting, and large area metal loss. For various implementations, training can be performed in stages. For example. for an implementation incorporating U-Net, the first stage can be a pixel-level classification into a set of simple integrity state labels. The first stage may be followed by a second stage where the morphological patterns are used to discriminate small versus large defect patterns that are semantically meaningful to operation. The training of such a two-stage model can be done separately or in combination, depending on various scenarios with different data and label availability.

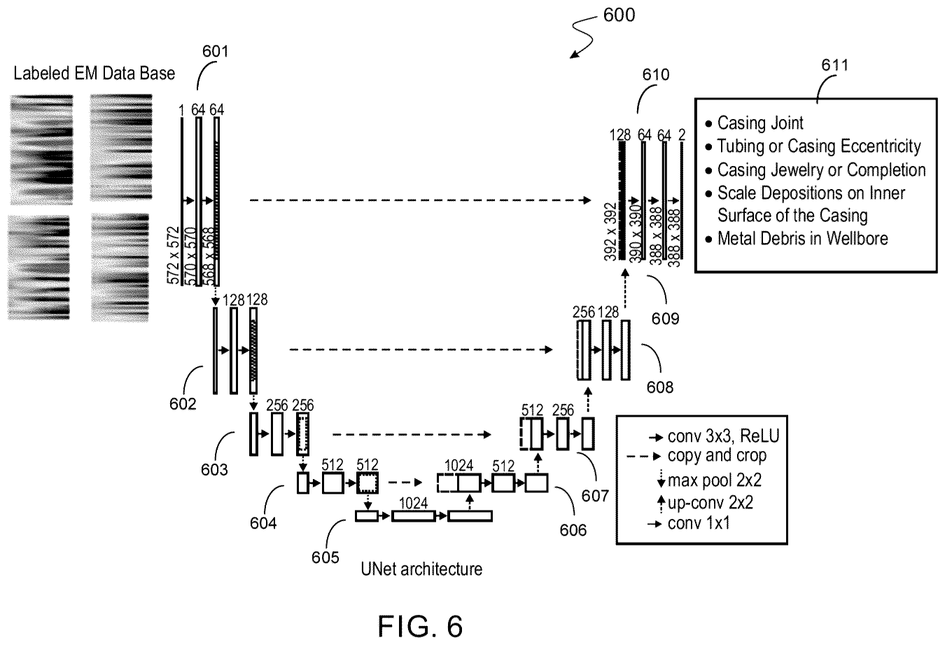

FIG. 6 illustrated an example of diagram of a machine learning/deep learning framework, according to some implementations of the present disclosure. Diagram 600 illustrates an example of a U-Net architecture used by some implementations of the present disclosure. In this example, block 601 illustrates a collection of input log images, such as EM spectrum map 504. Each image may be taken from a depth location (with a range), as demonstrated in FIGS. 1-5.

As illustrated, an input image of a size of 572×572 may be provided as input to a cascaded structure of a contracting path followed by an expanding path. In this example, the contracting path can include a series of convolutional layers followed by Max pooling and dropout operation. The convolutional layers consists of a number of convolution filters performing convolution of kernel size of, for example, 3×3 pixels, followed by an activation function, for example, a rectified linear unit (ReLU). The convolution filters may generate images of size, for example, 64×570×570, and then 64×568×568, after padding. Here 64 is the number of filters (channels) and 570×570 and 568×568 represent number of pixels for the image size for each channel. In this example, as illustrated in block 602, the image set of 64×568×568 can be subject to a Max pooling operation that down-samples the images spatially by performing, for example, a MAX operation within a mask of size 2×2. The subsequent image can be reduced to a size of 284×284. The image may then be subject to 128 convolution filters performing a convolution of size 3×3, thus generating images with trimmed sizes, for example, 128×282×282, and then 128×280×280. In block 603, the image set of 128×280×280 can be subject to a pooling operation that down-samples the images spatially by performing, for example, a MAX operation within a mask of size 2×2. The subsequent image can be reduced to a size of 140×140. The image may then be subject to a convolution filter performing a convolution of size 3×3, thus generating images with trimmed sizes, for example, 256×138×138, and then 256×136×136. In block 604, the image set of 256×136×136 can be subject to a pooling operation that down-samples the images spatially by performing, for example, a MAX operation within a mask of size 2/2. The subsequent image can be reduced to a size of 68×68. The image may then be subject to a convolution filter performing a convolution of size 3×3, thus generating images with trimmed sizes, for example, 512×66×66, and then 512×64×64. In block 605, the image set of 512×64×64 can be subject to a pooling operation that down-samples the images spatially by performing, for example, a MAX operation within a mask of size 2×2. The subsequent image can be reduced to a size of 32×32. The image may then be subject to a convolution filter performing a convolution of size 3×3, thus generating images with trimmed sizes, for example, 1024×30×30, and then 1024×28×28.

Subsequently, in block 606 of this example, the image set of size 1024×28×28 can be subject to an up-sampling convolution filter to generate an image set of 1024×56×56, the left half of which can be zero-padded. The image set may then be subject to a convolution filter performing a convolution of size 3×3, thus generating images with trimmed sizes, for example, 512×54×54, and then 512×52×52. In block 607 of this example, the image set of size 512×52×52 can be subject to an up-sampling convolution filter to generate an image set of 512×104×104, the left half of which can be zero-padded. The image set may then be subject to a convolution filter performing a convolution of size 3×3, thus generating images with trimmed sizes, for example, 256×102×102, and then 256×100×100. In this example, as illustrated in block 608 of this example. the image set of size 256×100×100 can be subject to an up-sampling convolution filter to generate an image set of 256×200×200, the left half of which can be zero-padded. The image set may then be subject to a convolution filter performing a convolution of size 3×3, thus generating images with trimmed sizes, for example, 128×198×198, and then 128×196×196. As illustrated in block 609 of this example, the image set of size 128×196×196 can be subject to an up-sampling convolution filter to generate an image set of 128×392×392, the left half of which can be zero-padded. The image set may then be subject to a convolution filter performing a convolution of size 3×3, thus generating images with trimmed sizes, for example, 64×390×390, and then 64×388×388, as illustrated in block 610 of this example. An output segmentation map of size 2×388×388 can thus be generated for mapping output 611. The architecture can incorporate pixel level or small defect classification in the mapping output for large area integrity mapping, and can effectively handle variations due to, e.g., casing joint variations, tubing/casing eccentricity, casing jewelry or completion items, scale depositions on inner surface of the casing, and metal debris in wellbore.

In another example, the implementations can use patch-based image classifiers such as those based on a CNN where each casing and/or tubing inspection image patch are classified into one of the integrity states and then assigned to the center pixel of the patch of pixels, and averaged over adjacent patches. In various examples, the image patches may overlap in space. The integrity state of each pixel can be determined from the patch classification label where this pixel is at the center location. Alternatively, or additionally, the classification output can be taken from all the image patches that covers the pixel of interest. The latter can be more robust in cases where the integrity feature has a certain morphological area that is not captured by a single image patch. The size of the image patch in this example may be chosen based on the typical resolution for integrity state of interest.

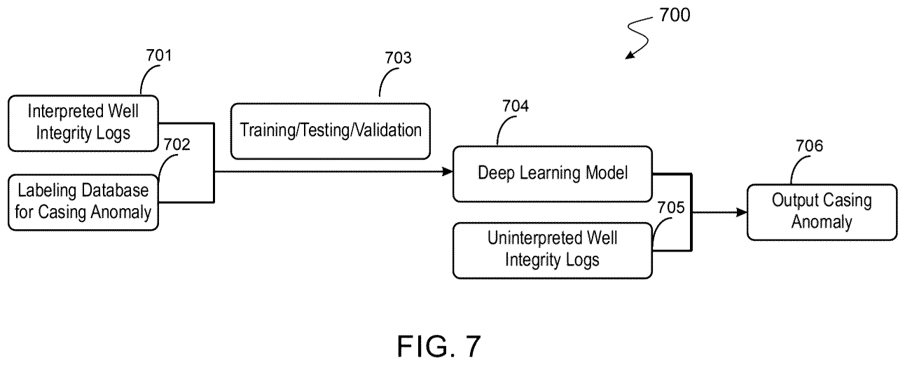

FIG. 7 illustrates an example of work-flow diagram, according to some implementations of the present disclosure. Diagram 700 of FIG. 7 illustrates an example of a work-flow process to identify anomaly using the ML model, according to some implementations of the present disclosure. The process may import the labeling database (for casing anomalies) 702 and the corresponding interpreted well integrity logs 701. The process may then train a deep leaning model based on the label for a given segment from the labeling database 702 and the associated log for given segment from the interpreted casing interpretation logs 701. The unplementations may also test the deep learning model using other parts of the labeling database 702 and the associated logs 701. The process can continue validating the deep learning model based on. for example, additional labeling and the associated logs. After completing the training, testing, and validation (703), the implementations may generate a deep learning model, for example, a U-Net deep learning model 704. The implementations may then apply the newly developed U-Net deep learning model to uninterpreted casing and/or tubing inspection logs (705) to generate the output interpretation (706).

The advantages of the implementations of the present disclosure include the ability to automatically and accurately differentiate metal loss features from those attributed to other factors as mentioned earlier. Currently, the other factors causing false apparent metal loss anomalies need to be manually edited through user actions such as data zonation, changing data processing parameters and offsets for each inspection log, which is a lengthy. impractical operation and prone to a lot of error. Using the workflow described above, implementations of the present disclosure can utilize a machine learning/deep learning algorithm to carry out an automated analysis of an electromagnetic time-based logging survey, thereby enabling an easy and efficient means of categorizing logging data features based upon their relevance to true pipe condition. This capability can allow an automated yet accurate metal loss quantification.

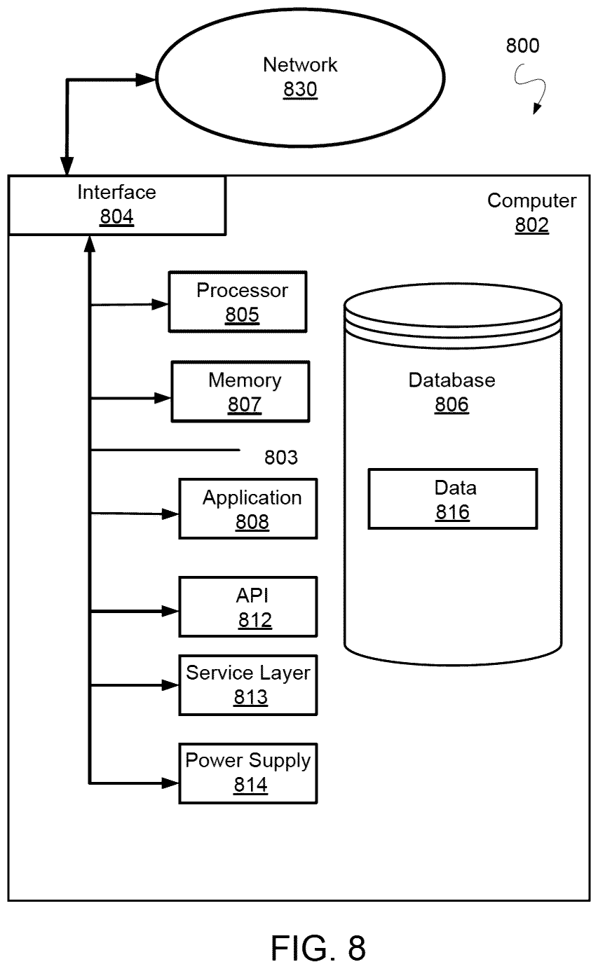

FIG. 8 is a block diagram 800 illustrating an example of a computer system 800 used to provide computational functionalities associated with described algorithms, methods, functions, processes, flows, and procedures, according to some implementations of the present disclosure. The illustrated computer 802 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 802 can comprise a computing device that includes an input device, such as a keypad, keyboard, touch screen, another input device, or a combination of input devices that can accept user information, and an output device that conveys information associated with the operation of the computer 802, including digital data, visual, audio, another type of information, or a combination of types of information, on a graphical-type user interface (UI) (or GUI) or other UI.

The computer 802 can serve in a role in a computer system as a client, network component, a server, a database or another persistency, another role, or a combination of roles for performing the subject matter described in the present disclosure. The illustrated computer 802 is communicably coupled with a network 830. In some implementations, one or more components of the computer 802 can be configured to operate within an environment, including cloud-computing-based, local, global, another environment, or a combination of environments.

The computer 802 is an electronic computing device operable to receive, transmit, process, store, or manage data and information associated with the described subject matter. According to some implementations, the computer 802 can also include or be communicably coupled with a server, including an application server, e-mail server, web server, caching server, streaming data server, another server, or a combination of servers.

The computer 802 can receive requests over network 830 (for example, from a client software application executing on another computer 802) and respond to the received requests by processing the received requests using a software application or a combination of software applications. In addition, requests can also be sent to the computer 802 from internal users, external or third-parties, or other entities, individuals, systems, or computers.

Each of the components of the computer 802 can communicate using a system bus 803. In some implementations, any or all of the components of the computer 802, including hardware, software, or a combination of hardware and software, can interface over the system bus 803 using an application programming interface (API) 812, a service layer 813, or a combination of the API 812 and service layer 813. The API 812 can include specifications for routines, data structures, and object classes. The API 812 can be either computer-language independent or dependent and refer to a complete interface, a single function, or even a set of APIs. The service layer 813 provides software services to the computer 802 or other components (whether illustrated or not) that are communicably coupled to the computer 802. The functionality of the computer 802 can be accessible for all service consumers using this service layer. Software services, such as those provided by the service layer 813, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 802. alternative implementations can illustrate the API 812 or the service layer 813 as stand-alone components in relation to other components of the computer 802 or other components (whether illustrated or not) that are communicably coupled to the computer 802. Moreover, any or all parts of the API 812 or the service layer 813 can be implemented as a child or a sub-module of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802. The interface 804 is used by the computer 802 for communicating with another computing system (whether illustrated or not) that is communicatively linked to the network 830 in a distributed environment. Generally, the interface 804 is operable to communicate with the network 830 and comprises logic encoded in software, hardware, or a combination of software and hardware. More specifically, the interface 804 can comprise software supporting one or more communication protocols associated with communications such that the network 830 or interface's hardware is operable to communicate physical signals within and outside of the illustrated computer 802.

The computer 802 includes a processor 805. Although illustrated as a single processor 805 in FIG. 8, two or more processors can be used according to particular needs, desires, or particular implementations of the computer 802. Generally, the processor 805 executes instructions and manipulates data to perform the operations of the computer 802 and any algorithms, methods, functions, processes, flows, and procedures as described in the present disclosure.

The computer 802 also includes a database 806 that can hold data 816 for the computer 802, another component communicatively linked to the network 830 (whether illustrated or not), or a combination of the computer 802 and another component. For example, database 806 can be an in-memory, conventional, or another type of database storing data 816 consistent with the present disclosure. In some implementations, database 806 can be a combination of two or more different database types (for example, a hybrid in-memory and conventional database) according to particular needs, desires, or particular implementations of the computer 802 and the described functionality. Although illustrated as a single database 806 in FIG. 8, two or more databases of similar or differing types can be used according to particular needs, desires, or particular implementations of the computer 802 and the described functionality. While database 806 is illustrated as an integral component of the computer 802. in alternative implementations, database 806 can be external to the computer 802. As illustrated, the database 806 holds data 816 including, for example, data from EM logs, as explained in more detail in association with FIGS. 1-7.

The computer 802 also includes a memory 807 that can hold data for the computer 802, another component or components communicatively linked to the network 830 (whether illustrated or not). or a combination of the computer 802 and another component. Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 or similar or differing types can be used according to particular needs, desires, or particular implementations of the computer 802 and the described functionality. While memory 807 is illustrated as an integral component of the computer 802, in alternative implementations, memory 807 can be external to the computer 802.

The application 808 is an algorithmic software engine providing functionality according to particular needs, desires, or particular implementations of the computer 802, particularly with respect to functionality described in the present disclosure. For example, application 808 can serve as one or more components, modules, or applications. Further, although illustrated as a single application 808, the application 808 can be implemented as multiple applications 808 on the computer 802. In addition, although illustrated as integral to the computer 802, in alternative implementations, the application 808 can be external to the computer 802.

The computer 802 can also include a power supply 814. The power supply 814 can include a rechargeable or non-rechargeable battery that can be configured to be either user- or non- user-replaceable. In some implementations, the power supply 814 can include power-conversion or management circuits (including recharging. standby, or another power management functionality). In some implementations, the power-supply 814 can include a power plug to allow the computer 802 to be plugged into a wall socket or another power source to, for example, power the computer 802 or recharge a rechargeable battery.

There can be any number of computers 802 associated with, or external to, a computer system containing computer 802, each computer 802 communicating over network 830. Further, the term “client,” “user,” or other appropriate terminology can be used interchangeably. as appropriate, without departing from the scope of the present disclosure. Moreover. the present disclosure contemplates that many users can use one computer 802. or that one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system. an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However. a computer need not have such devices. Moreover, a computer can be embedded in another device, for example, a mobile telephone, a personal digital assistant (PDA), a mobile audio or video player, a game console, a global positioning system (GPS) receiver. or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions. rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperable coupled with a hardware processor configured to perform the computer-implemented method or the instructions stored on the non-transitory. computer-readable medium.

What is claimed is:

1. A computer-implemented method comprising:
accessing a first database holding results of interpreting casing integrity, wherein each result provides a label for a detected anomaly at a depth location of an inspection log, wherein the label is one of: a first label of actual metal loss, or a second label of anomaly due to other factors, and wherein the inspection log records electromagnetic (EM) survey data of an underground metal casing that runs a plurality of depth locations;
accessing a second database holding inspection logs, wherein each inspection log record EM survey data of a corresponding underground metal casing that runs the plurality of depth locations;
based on, at least in part, the results of interpreting casing integrity, training a deep learning model configured to classify an input inspection log comprising an anomaly into the first label or the second label;
applying the deep learning model to one or more unclassified inspection logs of the second database, wherein the one or more unclassified inspection logs of the second database comprising anomalies; and
subsequently classifying the one or more unclassified inspection logs of the second database into either the first label or the second label.

2. The computer-implemented method of claim 1, further comprising:
analyzing the one or more unclassified inspection logs of the second database such that the anomalies in the one or more unclassified inspection logs are detected.

3. The computer-implemented method of claim 1, wherein each result from the first database is generated based on, at least in part, a determination by one or more human experts when presented with the inspection log along with the anomaly.

4. The computer-implemented method of claim 3, wherein each result from the first database is generated in view of a schematic of the underground metal casing at the plurality of depth locations.

5. The computer-implemented method of claim 4, wherein the schematic of the underground metal casing reveals at least one of: an eccentric casing pipe configuration, a decentered casing pipe configuration, and a casing pipe size transition.

6. The computer-implemented method of claim 1, wherein said EM survey data comprise an EM spectrum map corresponding to recorded EM decay curves from each transmitter-receiver combination on an EM logging tool lowered into the underground metal casing.

7. The computer-implemented method of claim 6, wherein the first label is characterized by a trapezoid pattern in the EM spectrum map at a depth location corresponding to the detected anomaly.

8. The computer-implemented method of claim 1, wherein the deep learning model includes a U-Net classifier.

9. The computer-implemented method of claim 8, wherein the U-Net classifier comprises:
a first stage configured to perform a pixel-level classification and classify each pixel or each patch of pixels into either the first label or the second label, and
a second stage of using morphological patterns to discriminate detected anomalies according to a respective pattern of each detected anomaly.

10. The computer-implemented method of claim 1, wherein the deep learning model includes a patch-based image classifier configured to operate on patches of pixels,
wherein the patch-based image classifier incorporates a convolutional neural network (CNN) classifier, and
wherein the CNN classifier comprises:
classifying, as a classified label, patches of each inspection image into one of the first label or the second label:
assigning the classified label to a center pixel of the patch; and
averaging over adjacent patches.

11. A computer system comprising one or more computer processors configured to perform operations of:
accessing a first database holding results of interpreting casing integrity, wherein each result provides a label for a detected anomaly at a depth location of an inspection log, wherein the label is one of: a first label of actual metal loss, or a second label of anomaly due to other factors, and wherein the inspection log records electromagnetic (EM) survey data of an underground metal casing that runs a plurality of depth locations;
accessing a second database holding inspection logs, wherein each inspection log record EM survey data of a corresponding underground metal casing that runs the plurality of depth locations;
based on, at least in part, the results of interpreting casing integrity, training a deep learning model configured to classify an input inspection log comprising an anomaly into the first label or the second label;
applying the deep learning model to one or more unclassified inspection logs of the second database, wherein the one or more unclassified inspection logs of the second database comprising anomalies; and
subsequently classifying the one or more unclassified inspection logs of the second database into either the first label or the second label.

12. The computer system of claim 11, wherein the operations further comprise:
analyzing the one or more unclassified inspection logs of the second database such that the anomalies in the one or more unclassified inspection logs are detected.

13. The computer system of claim 11, wherein each result from the first database is generated based on, at least in part, a determination by one or more human experts when presented with the inspection log along with the anomaly.

14. The computer system of claim 13, wherein each result from the first database is generated in view of a schematic of the underground metal casing at the plurality of depth locations.

15. The computer system of claim 14, wherein the schematic of the underground metal casing reveals at least one of: an eccentric casing pipe configuration, a decentered casing pipe configuration, and a casing pipe size transition.

16. The computer system of claim 11 of claim 11, wherein said EM survey data comprise an EM spectrum map corresponding to recorded EM decay curves from each transmitter-receiver combination on an EM logging tool lowered into the underground metal casing.

17. The computer system of claim 16, wherein the first label is characterized by a trapezoid pattern in the EM spectrum map at a depth location corresponding to the detected anomaly.

18. The computer system of claim 11, wherein the deep learning model includes a U-Net classifier.

19. The computer system of claim 18, wherein the U-Net classifier comprises:
a first stage configured to perform a pixel-level classification and classify each pixel or each patch of pixels into either the first label or the second label, and
a second stage of using morphological patterns to discriminate detected anomalies according to a respective pattern of each detected anomaly.

20. The computer system of claim 11, wherein the deep learning model includes a patch-based image classifier configured to operate on patches of pixels,
wherein the patch-based image classifier incorporates a convolutional neural network (CNN) classifier, and
wherein the CNN classifier comprises:
classifying, as a classified label, patches of each inspection image into one of the first label or the second label;
assigning the classified label to a center pixel of the patch; and
averaging over adjacent patches.
